(19) United States
(12) Patent Application Publication
(10) Pub. No.: US 2026/0007150 A1
(43) Pub. Date: Jan. 8, 2026

(54) METHODS FOR MANUFACTURING A SUSTAINABLE FOOD PRODUCT

(71) Applicant: B&T Technologies, LLC, Coral Springs, FL (US)

(72) Inventors: William H Moss, Coral Springs, FL (US); Anthony R Morgenthau, Coral Gables, FL (US)

(73) Assignee: B&T Technologies, LLC, Coral Springs, FL (US)

(21) Appl. No.: 19/043,972

(22) Filed: Feb. 3, 2025

Related U.S. Application Data
(60) Provisional application No. 63/573,079, filed on Apr. 2, 2024.

(51) Int. Cl. A23K 10/30; A23K 10/22; A23K 20/174; A23K 30/20; A23K 40/25; A23K 40/30

(52) U.S. Cl. CPC A23K 10/30; A23K 10/22; A23K 20/174; A23K 30/20; A23K 40/25; A23K 40/30

(57) ABSTRACT

A method for manufacturing a sustainable pet food product is disclosed, including the steps of first mixing a plurality of sustainable ingredients including adding and mixing one or more one or more virgin materials from at least one of the following: one or more dairy products, one or more meat and poultry products, one or more fish products, one or more egg products, and a rendered protein meals. Next, one or more vitamins and one or more minerals are added and mixed to the plurality of sustainable ingredients to create a dough. The dough is pressure cooked in a pressure cooking vessel and then extruded, via an extruder, the dough to create a plurality of ribbons. A rotary blade cuts the plurality of ribbons to create a wet kibble which is then dried. Once dried, the kibble is coated with one or more flavorants which are then dried to a surface of the dry kibble to produce a sustainable pet food product. Further, methods for producing a sustainable food product from unsold and unused produce using virgin cereal grains, fruits, and/or vegetables are disclosed.

### CROSS-REFERENCE TO RELATED APPLICATIONS

The present application claims priority to U.S. Provisional Patent Application No. 63/557,281 filed Feb. 23, 2024, titled “METHOD FOR MANUFACTURING PET FOOD FROM SUSTAINABLE MATERIALS”; and U.S. Provisional Application No. 63/573,079 filed Apr. 2, 2024, titled “METHOD FOR MANUFACTURING SUSTAINABLE FOOD”, each of which is hereby incorporated by reference in its entirety.

### TECHNICAL FIELD

The present invention relates generally to method for making a food product from sustainable materials.

### BACKGROUND

Dry pet foods are made by mixing dry and wet ingredients together to form a dough that can be extruded into shapes that are edible by pets (for example, dog kibble). The dry ingredients are virgin cereal grains mixed with fruits and vegetables, dairy and egg products, meat and poultry products, fish, rendered protein meals, broth, vegetable oil and minerals. The dough is cooked/heated under high pressure, then pushed through a die machine that cuts the kibbles. Kibble size and shape varies according to the product specification. The kibbles are dried, cooled and spray coated.

The dry mix is combined with wet ingredients, water and steam in a preconditioner, which hydrates the powders, creates a dough and starts the cooking process. The dough then enters a machine known as an extruder, which cooks the dough under pressure. At the end of the extruder the dough exits under pressure through a die plate creating ribbons of pre-specified shape that are then sliced into the pre-specified size using a rotary cutter. After extrusion and cutting, the kibbles are air dried in an oven to remove moisture. Reducing the moisture content is an important step in maintaining freshness and preventing food spoilage. After drying and cooling, kibbles often enter a revolving drum where they are evenly coated with a mix of flavors to enhance taste, and preservatives to prevent spoilage through the shelf life of the food. Flavors or other coatings may also be sprayed on baked foods as they exit the oven.

The nutritional ingredients in pet food are water proteins, fats, carbohydrates, vitamins and minerals. To achieve the right balance of nutrients pet food manufacturers blend mixtures of ingredients including meat and fish, vegetables, cereals, vitamins and minerals to produce foods that will satisfy the nutritional requirements of the pet (species, breed, size, activity-level, and age). The cereal ingredients are sourced from virgin grains, not upcycled food waste.

Regarding the human food industry, unsold/unused food, particularly fresh vegetables or fresh fruit are being discarded and sent to a landfills for ultimate disposal. This can include bruised or blemished fruit, vegetables that are slightly wilted, and other produce that consumers do not chose but are still suitable for human consumption. These raw materials can be processed into dehydrated/dry powder with a shelf life of 6-9 months. Individual fruits and vegetables, or combinations of fruits and/or vegetables in dry powder form can be used as ingredients in manufactured food products as substitutes for virgin materials without any loss of nutrition or other sensory attributes, such as appearance, odor, flavor, taste, and texture of foods detectable by human senses.

The material drying process described elsewhere (see U.S. Pat. No. 5,596,815A and U.S. Patent Applications #63/556,739 and #63/558,422) is a process to dehydrated/dry unsold/unused food into a dry powder ingredient that substitute virgin ingredients in the manufactured food products.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a method for manufacturing a sustainable pet food product. First, sustainable ingredients (including one or more virgin materials such as dairy products, egg products, meat products, poultry products, fish products, and/or rendered protein meals) are mixed with vitamins and minerals to create a dough which is placed in a pressure cooker. Once the dough has been pressure cooked for a sufficient period of time, the dough is extruded to create ribbons which can be cut into kibbles. The kibbles are then dried and one or more flavorants are applied to the kibbles. The flavored kibble is then dried and packaged for distribution.

In some aspects, the one or more flavorants are added as a top coating after extrusion of the plurality of ribbons, wherein the one or more flavorants are comprised of one or more dry powder flavorants and one or more liquid flavorants.

In some aspects, the one or more flavorants are applied via the following steps: applying a layer of a fat or an oil to coat the dry kibble; applying the one or more flavorants onto the dry kibble; and mixing the one or more flavorants into the dry kibble.

The method provides an alternative and sustainable process which does not use virgin cereal grains and vegetables. Rather the method utilizes dehydrated food waste derived from sustainable unsold and/or unused food.

The use of sustainable materials diverts these materials from the ultimate disposal in landfills, saving scarce, permitted landfill space for unrecyclable municipal solid waste. These sustainable materials also produce greenhouse gas emissions (Methane gas and CO2) when they decompose in landfills. Their use in the method described herein reduces the environmental burden of these materials being placed in landfills.

Traditionally, cereal-type pet feed ingredients are typically dry ingredients such as wheat, flour, potato starch, rice flour or wheat starch, which are all derived from grains that require moist soil which is unavailable in the subtropical aridity of the Arabian desert. As a consequence, all animal feed is imported. By using sustainable raw materials to replace imported grains, countries improve feed and food security by replacing imported pet food ingredients with pet food ingredients which are manufactured locally.

Using sustainable materials, as is described by the method disclosed herein, provides a product having a lower price than standard pet feed ingredients in countries that cannot grow wheat, potatoes, rice, corn, and other grains for pet feed ingredients. The cost savings can be upwards of 30% over standard manufacturing in some circumstances.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1A illustrates prior art including a simple flowchart of a method for manufacturing pet food using virgin materials, according to some embodiments;

FIG. 1B illustrates prior art including a detailed flowchart of a method for manufacturing pet food using virgin materials, according to some embodiments;

FIG. 2 illustrates a detailed flowchart of a method for manufacturing pet food using sustainable materials, according to some embodiments;

FIG. 3 illustrates a process for drying a mixture of a one or more wet and one or more dry sustainable materials, according to some embodiments; and

FIG. 4 illustrates a process for drying a mixture of one or more wet sustainable materials, according to some embodiments.

FIG. 5 illustrates flowchart of a material drying process to process unsold/unused carrots into dehydrated/dried sustainable carrot powder/pellets, according to some embodiments;

FIG. 6 illustrates flowchart of a material drying process to process unsold/unused potatoes into dehydrated/dried sustainable potato powder/pellets, according to some embodiments;

FIG. 7 illustrates flowchart of a material drying process to process unsold/unused blueberries into dehydrated/dried sustainable blueberry powder/pellets, according to some embodiments;

FIG. 8 illustrates a flowchart of a material drying process to process unsold/unused source-separated supermarket produce discards before they are disposed in a landfill, according to some embodiments;

FIG. 9 illustrates prior art food manufacturing using virgin cereal grains, virgin fruits and vegetables, and other ingredients to produce process/packaged food, according to some embodiments; and

FIG. 10 illustrates a method for manufacturing sustainable food using unsold/unused fruit and/or unsold/unused vegetables and/or unsold/unused single ingredients (e.g., carrots) as inputs to the material drying process to produce dehydrated/dry unsold/unused produce and dehydrated/dry unsold/unused single ingredients (e.g., carrots) as substitutes for virgin ingredients along with other ingredients to produce process/packaged food, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein are an improvement to a method for manufacturing pet food using sustainable materials. The method uses dehydrated food waste (such as those derived from sustainable unsold and/or unused food) in place of virgin grains or processed virgin cereal grains as ingredients in pet food. In such, the method utilizes food waste that otherwise would have ended in landfill. The production materials are sourced either from unsold or unused factory food waste (pre-consumer food waste) or food that has reached the market but is unsold and intended to be culled and then mixed with garbage (grocery store food waste).

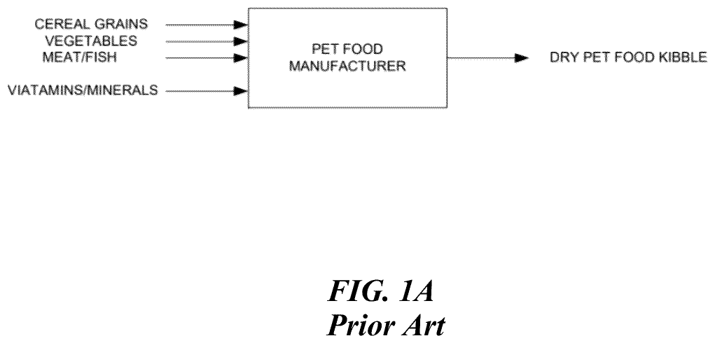

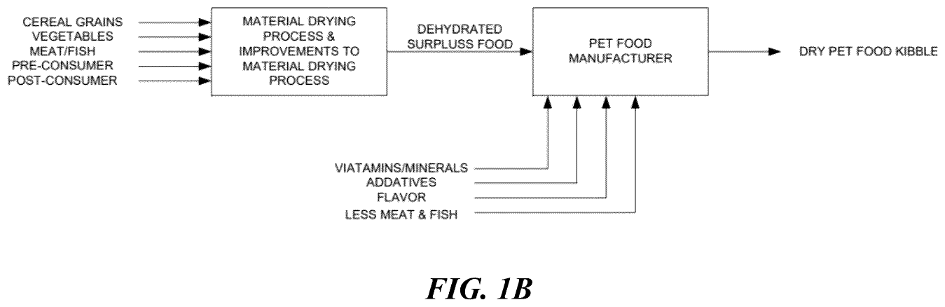

FIG. 1A and FIG. 1B illustrate a prior art references showing flowcharts for methods of manufacturing pet food.

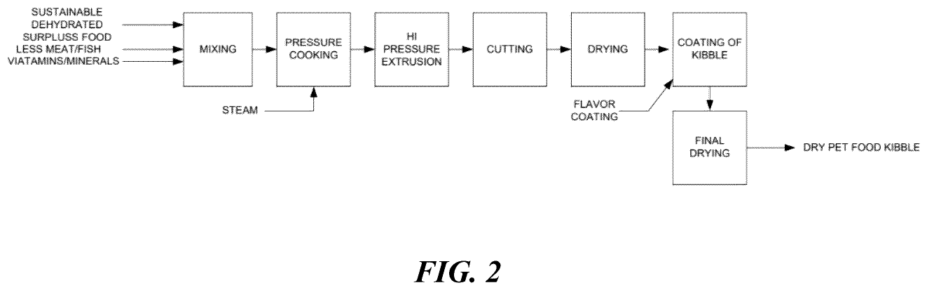

FIG. 2 illustrates a flowchart of a method for manufacturing pet food using sustainable materials.

The process described herein includes dehydrated food waste that is used as a substitute for the dry virgin cereal grains that are used in current methods for making pet food. The dehydrated food waste can be made from grocery store produce (unused/unsold fruits and vegetables). The ingredients in the dehydrated food waste can also include residuals and byproducts from grocery store meat and deli departments and manufacturers of salad dressings, humus, dairy products (e.g., ice cream, butter, cheese, pasta dough, dry bakery products, etc.) to increase protein and fat content, reducing the need to add meat, fish and vegetables to cereal grains in current pet food manufacturing.

Sustainable materials are subjected to a material drying process. The dehydrated sustainable materials are provided to a pet food manufacturer who may add various vitamins, minerals, additives, flavorants, and other ingredients to produce dry pet food kibble.

The sustainable dehydrated material, vitamins, minerals, additives, flavorants, and other ingredients are mixed and then heated in a pressure cooking vessel to create a dough. The dough is then transferred through a high pressure extruder creating ribbons of a pre-specified shape that are then sliced into the pre-specified size using a rotary cutter. After extrusion and cutting, the kibbles are air dried in an oven to remove moisture. After drying and cooling, kibbles often enter a revolving drum where they are evenly coated with a mix of flavors to enhance taste, and preservatives to prevent spoilage through the shelf life of the food. Flavorants or other coatings may also be sprayed on baked foods as they exit the dryer. Following a final drying step, the pet food kibble may then be packaged and distributed.

The moisture content in the dehydrated food process (the material drying process for sustainable materials) can be higher (20-22%) rather than <10% since the dehydrated food waste ingredient will be used to make dough with 15-25% moisture prior to cooking with steam at high pressure.

The pet food manufacturing processes illustrated in FIGS. 1A-1B remain unchanged except for the substitution of dehydrated food waste from sustainable ingredients for virgin cereal grains and vegetables.

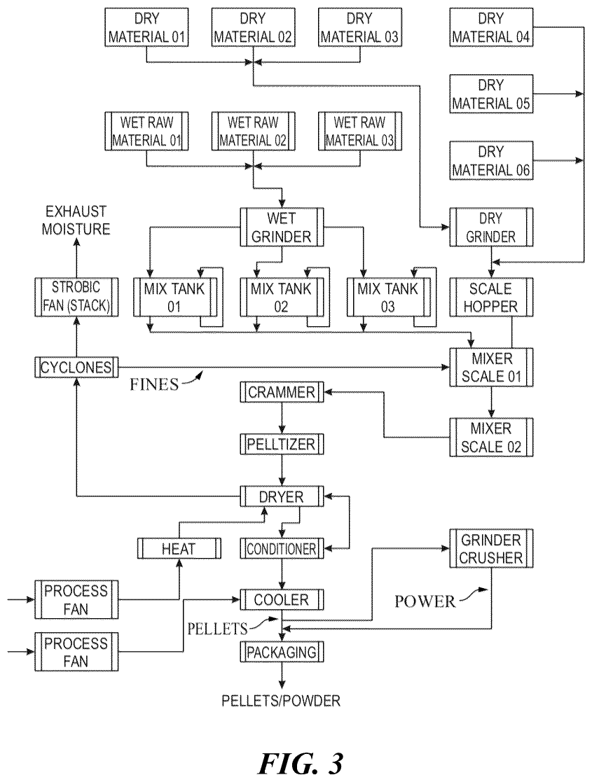

FIG. 3 illustrates an exemplary process for drying the sustainable materials for use in the sustainable pet food product described herein. One or more mixers in series enable efficient charging of a batch in the first mixer such that an operator can vary the recipe used in each batch. The texturized material is mixed and transferred to the pelletizer with a second mixer. The process can accommodate multiple dry feed inputs and multiple wet feed inputs, with wet feed inputs recirculated to get concentration equalization (homogenization) for wet raw materials with common characteristics (for example, low fiber or high fiber). Each batch can be charged with specific relative ratios of ingredients from multiple wet and dry inputs to manufacture target specific pet feed products for low fiber, high fiber, high fat/protein, or low fat/high protein requirements. In such, multiple wet raw material classes can be concentration-equalized. The process allows for multiple products to be manufactured from multiple wet and dry raw materials.

This drying process may yield a final product that is below 10% moisture which is considered dehydrated/dried and has a long shelf-lift (e.g., 6-9 months or more).

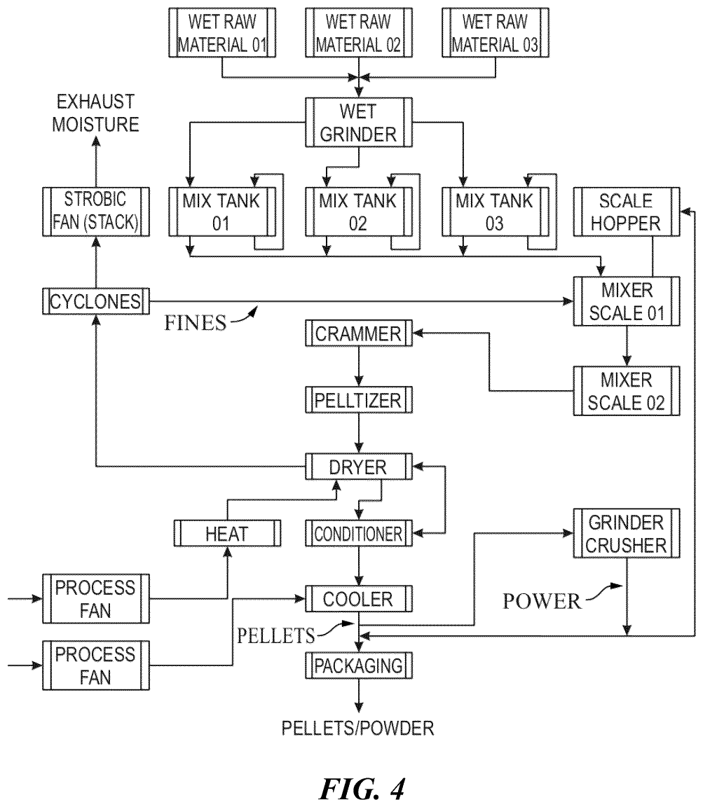

FIG. 4 illustrates an alternative process for drying all wet raw sustainable materials for use in the sustainable pet food product described herein. In this exemplary process, the wet raw sustainable material is placed in a wet grinder for a sufficient time period to grind the wet raw material. The ground wet raw material is then mixed in mix tanks before being placed in a crammer and then a pelletizer to pelletize the material. Once pelletized, the material is then transmitted to a dryer wherein heat and process fans dry the product before they are placed in a conditioner, and eventually a cooler. Following cooling, the material is transmitted to a grinder/crusher and then packaged as a pellet or powder.

In some embodiments, the processes disclosed herein provide an improvement to a method for manufacturing replacing virgin food ingredients with sustainable materials. The method uses dehydrated/dry unsold/unused food that has been processed by the material drying process in place of virgin cereal grains and virgin fruits and vegetables as ingredients in manufacturing of processed foods. In such, the method utilizes unused and unsold food that otherwise would have ended in landfill. The production materials are sourced either from unsold or unused food from produce markets and manufacturers (pre-consumer food waste) or food that has reached the market but is unsold (grocery store food waste).

Unsold/unused food, particularly fresh vegetables or fresh fruit that are being discarded and sent to a landfill for ultimate disposal are used as raw materials in the material drying process. These materials are dehydrated/dried into a powder or pellet before the material ripens and rots. The material can be a single healthy ingredient (such as pure carrot, pure potato or pure blueberry), or it can be a mixture of all vegetables, all fruit, or all produce which have been unsold and will be disposed of in a landfill. These materials can be used as ingredients to substitute for virgin materials in animal feed or human food recipes, making said animal feed or human food sustainable, healthier, and lower in cost.

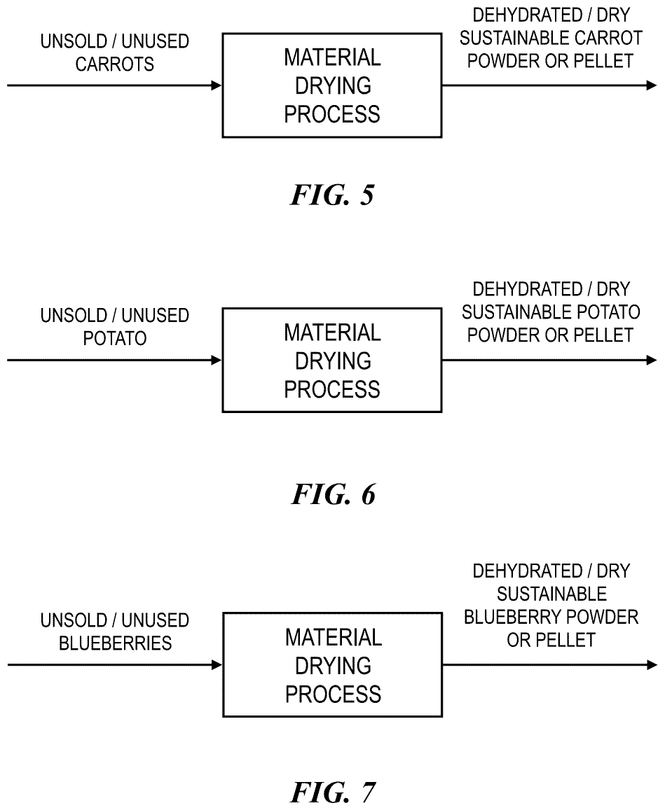

FIGS. 5-7 illustrate methods for using the material drying process to process unsold/unused produce (i.e., carrots, potatoes, blueberries, etc.) into sustainable dehydrated/dry powder or pellet for use as an animal food product.

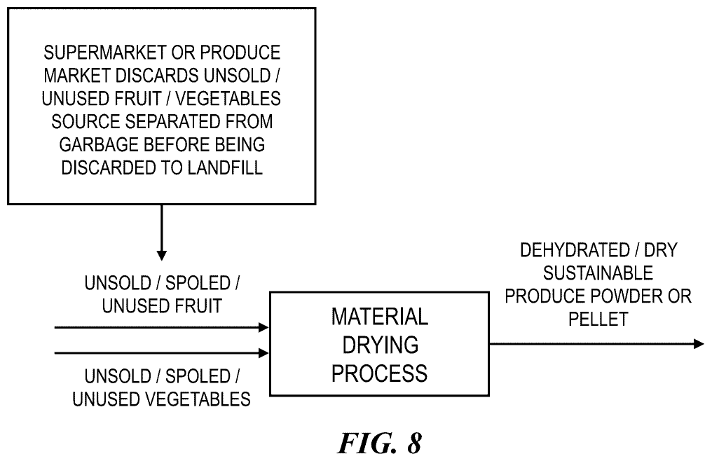

FIG. 8 illustrates the method for using the material drying process to process supermarket or produce market unsold/unused food (discards) into dehydrated/dry sustainable produce powder or pellet. The term “source separated” may be used to describe the process and resulting ingredients collected by separating usable components of the discarded waste at a supermarket, produce market, grocery store, etc.

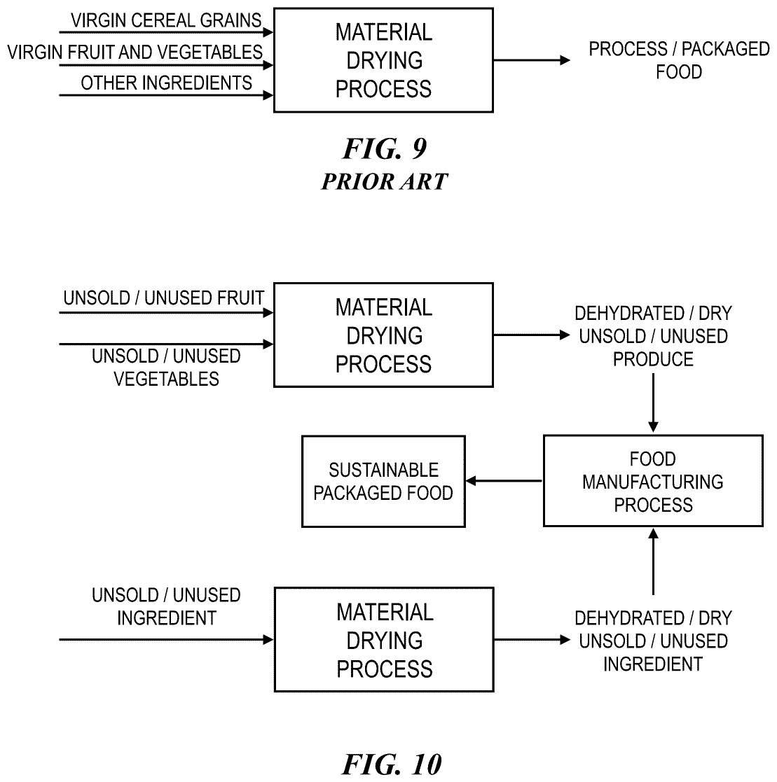

FIG. 9 illustrates prior art wherein virgin cereal grains, virgin fruits and vegetables, and other ingredients are inputs to any food manufacturing process to produce processed/packaged food.

FIG. 10 illustrates how dehydrated sustainable materials are provided to a human food or pet food manufacturer who may add various vitamins, minerals, additives, flavorants, and other ingredients to produce sustainable packaged food.

The food manufacturing processes illustrated in FIGS. 8-10 remain relatively the same except for the substitution of dehydrated sustainable ingredients for virgin cereal grains. fruits and vegetables.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A method for manufacturing a sustainable pet food product, the method comprising the steps of:
mixing a plurality of sustainable ingredients;
adding and mixing one or more virgin materials from at least one of the following: one or more dairy products, one or more meat and poultry products, one or more fish products, one or more egg products, and a rendered protein meals;
adding and mixing one or more vitamins and one or more minerals to the plurality of sustainable ingredients and virgin materials to create a dough;
pressure cooking the dough in a pressure cooking vessel;
extruding, via an extruder, the dough to create a plurality of ribbons;
cutting, via a rotary blade, the plurality of ribbons to create a wet kibble;
drying the wet kibble to produce a dry kibble;
coating the dry kibble with one or more flavorants; and
drying the one or more flavorants to a surface of the dry kibble to produce a sustainable pet food product.

2. The method for manufacturing a sustainable pet food product of claim 1, wherein the one or more flavorants are added as a top coating after extrusion of the plurality of ribbons, wherein the one or more flavorants are comprised of one or more dry powder flavorants and one or more liquid flavorants.

3. The method for manufacturing a sustainable pet food product of claim 2, wherein the one or more flavorants are applied via the following step:
applying a layer of a fat or an oil to coat the dry kibble;
applying the one or more flavorants onto the dry kibble; and
mixing the one or more flavorants into the dry kibble.

4. The method of claim 3, wherein the one or more liquid flavorants are applied to the dry kibble before applying the one or more dry powder flavorants.

5. The method of claim 4, wherein the one or more flavorants are applied using a volumetric pump to topically apply the one or more flavorants to the dry kibble.

6. The method for manufacturing a sustainable pet food product of claim 1, wherein the sustainable pet food product is below 10% moisture.

7. The method for manufacturing a sustainable pet food product of claim 3, wherein the sustainable pet food product is stable for 6-9 months.

8. The method for manufacturing a sustainable pet food product of claim 1, further comprising the step of: drying the sustainable pet food product.

9. The method for manufacturing a sustainable pet food product of claim 5, further comprising the step of: packaging the sustainable pet food product in a food-safe container.

10. A method for manufacturing a food product using unsold and unused produce, the method comprising the steps of:
separating a plurality of discarded produce before the plurality of discarded produce is disposed in a landfill; and
processing the plurality of discarded produce using a material drying process to manufacture a sustainable food product used to substitute a virgin material in a food manufacturing process.

11. The method for manufacturing a food product of claim 7, wherein the plurality of discarded produce is comprised of a plurality of unsold or unused vegetables.

12. The method for manufacturing a food product of claim 7, wherein the plurality of discarded produce is comprised of a plurality of unsold or unused fruits.

13. The method for manufacturing a food product of claim 7, wherein the plurality of discarded produce is comprised of each of a plurality of unsold or unused vegetables and a plurality of unsold or unused fruits.

14. The method for manufacturing a food product of claim 7, wherein discarded produce is a singular item of a fruit or a vegetable.
